(19) United States
(12) Patent Application Publication
(10) Pub. No.: US 2016/0046231 A1
(43) Pub. Date: Feb. 18, 2016

(54) VEHICLE DECELERATION WARNING SYSTEM

(71) Applicant: DEERE & COMPANY, Moline, IL (US)

(72) Inventors: SCOTT C. STEEGE, DENVER, IA (US); SHANE M. BODEN, LAWRENCE, KS (US)

(21) Appl. No.: 14/460,033

(22) Filed: Aug. 14, 2014

(51) Int. Cl. B60Q 1/44

(52) U.S. Cl. CPC B60Q 1/44

(57) ABSTRACT

A vehicle deceleration warning system includes a primary brake pedal sensor, a secondary brake control sensor, a transmission sensor, a wheel speed sensor, a visual indicator, and a control unit which receives the sensor signals and controls activation of the indicator. The control unit activates the indicator when the sensor signals indicate that the vehicle is decelerating. The indicator may be a brake light or a lamp separate from the standard brake lights.

### FIELD OF THE INVENTION

The present disclosure relates to vehicle warning system and more particularly, to vehicle deceleration warning system.

### BACKGROUND OF THE INVENTION

Off-road vehicles, such as agricultural tractors, are also operated on roads and highways. It is known to activate brake lights using a sensor on the brake pedals to sense when the brake pedals have been displaced from a neutral position. However, an operator can slow down such a vehicle without using the service brakes or the secondary brake. When a tractor is operated in this manner, the brake lights will not be illuminated to signal to rear approaching vehicles that the tractor is slowing or stopping. It is desired to provide such vehicles with a system for signaling deceleration, even when the vehicle brakes are not being activated.

### SUMMARY

According to an aspect of the present disclosure, a vehicle deceleration warning system includes a primary brake pedal sensor for sensing primary brake pedal operation and generating a primary brake activation signal, a secondary brake control sensor for sensing secondary brake control operation and generating a secondary brake activation signal, a transmission sensor for generating a transmission condition signal, a wheel speed sensor for sensing wheel speed and generating a wheel speed signal, a visual indicator, and a control unit which receives the parameter signal and controls activation of the indicator. The control unit activates the indicator when the parameter signals indicate that the vehicle is decelerating. The indicator may be a brake light or a lamp separate from the standard brake lights.

The control unit turns the indicator light on if the transmission of the vehicle is commanded to a powered zero speed condition. The control unit turns the indicator light off if a transmission of the vehicle is commanded to park or neutral condition. The control unit turns the indicator light off if vehicle speed exceeds a speed threshold. The control unit turns the indicator light on if wheel speed is greater than a first speed threshold and vehicle acceleration is less than a first acceleration threshold.

The control unit turns the indicator light off after a predetermined time period if wheel speed is greater than a second speed threshold or vehicle acceleration is greater than a second acceleration threshold. The control unit turns the indicator light off immediately if vehicle acceleration is greater than zero. The control unit turns the indicator light on if a brake device is activated, and the control unit turns the indicator light off if the brake device is de-activated.

### BRIEF DESCRIPTION OF THE DRAWINGS

FIG. 1 is a schematic diagram of a vehicle deceleration warning system embodying the invention;

FIG. 2 is a diagram illustrating the functions performed by the ECU of FIG. 1.

### DETAILED DESCRIPTION OF THE DRAWINGS

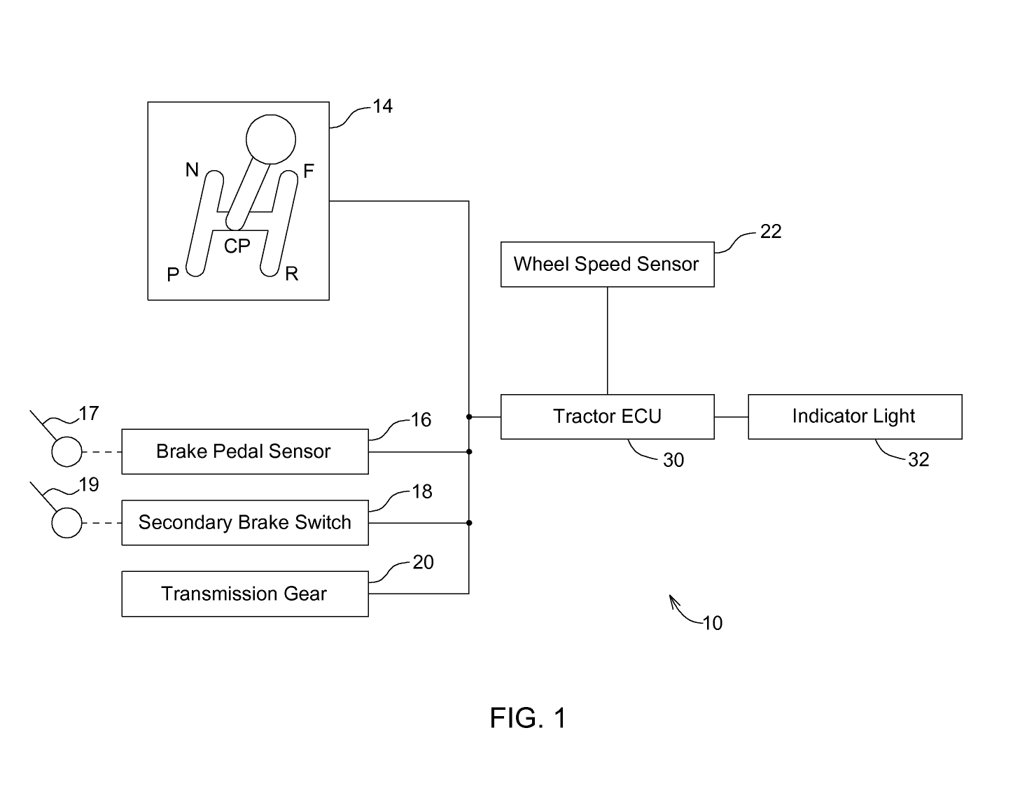

Referring to FIG. 1, the vehicle deceleration warning system 10 includes a transmission shift position sensor 14, a primary or service brake pedal activation sensor 16 operatively coupled to a primary brake pedal 17, a secondary brake switch activation sensor 18 operatively coupled to a secondary brake control 19, a transmission gear sensor 20 and a vehicle or wheel speed sensor 22. The transmission gear signal may be provided by a transmission controller (not shown). Vehicle acceleration is calculated based on wheel speed change over time.

Signals from sensors 14-22 are received by a microprocessor-based tractor electronic control unit (ECU) 30. The ECU 30 is connected to an indicator 32, which could be a brake light or a lamp separate from a brake light. The indicator 32 could be a lamp at the top center of the cab (not shown) in order to improve visibility, since an implement could interfere with visibility of standard tractor brake lights. The ECU controls activation of the indicator 32 as a function of the signals from sensors 14-22.

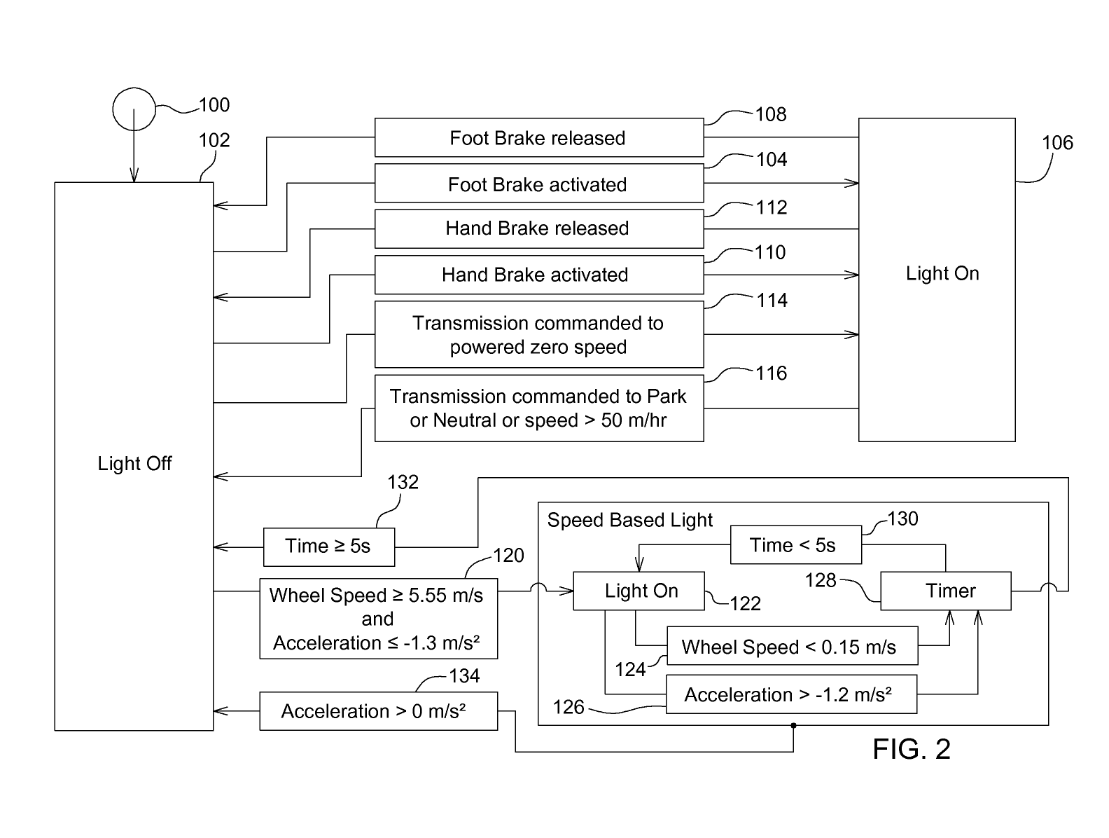

The ECU 30 thereby processes the signals from sensors 14-22 and controls activation of the brake light 32 as indicated by the diagram of FIG. 2. The conversion of the diagram of FIG. 2 into a standard language for implementing the algorithm described by the flow chart in a digital computer or microprocessor will be evident to one with ordinary skill in the art.

Following initialization at block 100, the indicator light 32 will be turned off as indicated by block 102.

If the foot brake 15 is activated (block 104), then the indicator light 32 will be turned on as indicated by block 106.

If the indicator light 32 is on and the foot brake 15 is de-activated (block 108), then the indicator light 32 will be turned off (block 102).

If the secondary brake 17 is activated (block 110), then the indicator light 32 will be turned on as indicated by block 106.

If the indicator light 32 is on and the secondary brake 17 is de-activated (block 112), then the indicator light 32 will be turned off (block 102).

If the transmission is commanded to powered zero speed (block 114), then the indicator light 32 will be turned on as indicated by block 106. A transmission is in a “powered zero” condition when the transmission has been put into a forward or reverse gear, but has zero speed.

If the indicator light 32 is on and transmission is commanded to Park or Neutral or speed is less than 50 meters per hour (block 116), then the indicator light 32 will be turned on (block 102).

Returning to block 102, if the indicator light 32 is off and wheel speed is greater than or equal to a threshold speed (such as 5.55 meters per second) and acceleration is less than or equal to an acceleration threshold (such as −1.3 m/sec²) (block 120), then the indicator light 32 will be turned on as indicated by block 122. As a result, the indicator light 32 will turn on if deceleration is high only about a speed threshold of about 20 kph.

If the indicator light 32 is on as a result of block 122 and wheel speed is less than a speed threshold of 0.15 m/sec (block 124) or if acceleration is greater than an acceleration threshold (such as −1.2 m/sec²) (block 126), then a timer (blocks 128, 130) will hold the indicator light 32 on for a desired time period (such as 5 seconds). When the timer period has elapsed (block 132), then the indicator light 32 will be turned off (block 102).

If acceleration is greater than a threshold (such as 0 m/sec) (block 134), then the indicator light 32 will be turned off (block 102). This occurs without any time delay so that the indicator light is immediately turned off if the vehicle accelerates.

The result is a system which controls a brake light or an indicator light as a function of vehicle deceleration and as a function of normal service brake pedal or secondary brake operation. Different deceleration rates and thresholds may be used for different transmission combinations including, infinitely variable, power shift, as well as others.

Thus, the control unit analyzes operator inputs and vehicle conditions, and determines the status of the service brakes, secondary brakes, transmission powered zero condition, or if the tractor is decelerating due to hand throttle position, foot throttle position, or if transmission speed decreasing (due to gear change, or transmission control pulled rearward to slowdown). The control unit illuminates an indicator or brake lights when the service brakes or secondary brakes are actuated, and turns it off when these inputs return to a neutral state. The indicator light will also be illuminated when the control unit determines the vehicle has exceeded a minimum velocity threshold (indicating a transport condition) and is decelerating at a rate that crosses a predetermined value, and illumination will be maintained for fixed amount of time after the deceleration has been halted.

The indicator light will be illuminated when the transmission is put into a “powered zero” condition. This condition may occur when the vehicle is at a stoplight, stop sign or intersection, but the operator is not using the service brakes nor secondary brake to keep the vehicle from moving. In this case the warning system generates a warning signal to rearward approaching vehicles that the vehicle is slowing or stopped.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. A vehicle deceleration warning system comprising:
a vehicle parameter sensor, other than a brake parameter sensor, for sensing vehicle deceleration and generating a parameter signal;
a visual indicator; and
a control unit which receives the parameter signal and controls activation of the indicator, the control unit activating the indicator when the parameter signal represents deceleration of the vehicle.

2. The vehicle deceleration warning system of claim 1, wherein:
the indicator comprises a brake light.

3. The vehicle deceleration warning system of claim 1, wherein:
the parameter sensor comprises a vehicle or wheel speed sensor.

4. The vehicle deceleration warning system of claim 1, wherein:
the control unit turns the indicator light on if a transmission of the vehicle is commanded to a powered zero speed condition.

5. The vehicle deceleration warning system of claim 1, wherein:
the control unit turns the indicator light off if a transmission of the vehicle is commanded to park or neutral condition.

6. The vehicle deceleration warning system of claim 1, wherein:
the control unit turns the indicator light off if vehicle speed exceeds a speed threshold.

7. The vehicle deceleration warning system of claim 1, wherein:
the control unit turns the indicator light on if wheel speed is greater than a first speed threshold and vehicle acceleration is less than a first acceleration threshold.

8. The vehicle deceleration warning system of claim 7, wherein:
the control unit turns the indicator light off after a predetermined time period if vehicle acceleration is greater than a second acceleration threshold.

9. The vehicle deceleration warning system of claim 7, wherein:
the control unit turns the indicator light off immediately if vehicle acceleration is greater than zero.

10. The vehicle deceleration warning system of claim 1, wherein:
the control unit turns the indicator light on if a brake device is activated; and
the control unit turns the indicator light off if the brake device is de-activated.

11. A vehicle deceleration warning system comprising:
a primary brake pedal sensor for sensing primary brake pedal operation and generating a primary brake activation signal;
a secondary brake control sensor for sensing secondary brake control operation and generating a secondary brake activation signal;
a transmission sensor for generating a transmission condition signal;
a wheel speed sensor for sensing wheel speed and generating a wheel speed signal;
a visual indicator; and
a control unit which receives the parameter signal and controls activation of the indicator, the control unit activating the indicator when the parameter signal represents deceleration of the vehicle.

12. The vehicle deceleration warning system of claim 11, wherein:
the indicator comprises a brake light.

13. The vehicle deceleration warning system of claim 11, wherein:
the parameter sensor comprises a vehicle or wheel speed sensor.

14. The vehicle deceleration warning system of claim 11, wherein:
the control unit turns the indicator light on if a transmission of the vehicle is commanded to a powered zero speed condition.

15. The vehicle deceleration warning system of claim 11, wherein:
the control unit turns the indicator light off if a transmission of the vehicle is commanded to park or neutral condition.

16. The vehicle deceleration warning system of claim 11, wherein:
the control unit turns the indicator light off if vehicle speed exceeds a speed threshold.

17. The vehicle deceleration warning system of claim 11, wherein:
the control unit turns the indicator light on if wheel speed is greater than a first speed threshold and vehicle acceleration is less than a first acceleration threshold.

18. The vehicle deceleration warning system of claim 17, wherein:
the control unit turns the indicator light off after a predetermined time period if vehicle acceleration is greater than a second acceleration threshold.

19. The vehicle deceleration warning system of claim 17, wherein:
the control unit turns the indicator light off immediately if vehicle acceleration is greater than zero.

20. The vehicle deceleration warning system of claim 11, wherein:
the control unit turns the indicator light on if a brake device is activated; and
the control unit turns the indicator light off if the brake device is de-activated.
